(19) United States
(12) Patent Application Publication
(10) Pub. No.: US 2020/0356571 A1
(43) Pub. Date: Nov. 12, 2020

(54) DETECTION OF ANOMALOUS SYSTEMS

(71) Applicant: Oxford University Innovation Limited, Oxford (GB)

(72) Inventors: David WALLOM, Oxford (GB); Neil CAITHNESS, Reading (Berkshire) (GB)

(21) Appl. No.: 16/641,261

(22) PCT Filed: Aug. 20, 2018
(86) PCT No.: PCT/GB2018/052357

§ 371 Date: Feb. 24, 2020

(30) Foreign Application Priority Data
Aug. 25, 2017 (GB) 1713703.5
Aug. 30, 2017 (GB) 1713896.7

(51) Int. Cl. G06F 16/2457; G06F 16/2455; G06K 9/62; G06F 16/248; G06F 16/901; H04Q 9/02

(52) U.S. Cl. CPC G06F 16/24578; G06F 16/24554; G06K 9/6215; G06Q 50/06; G06F 16/9024; H04Q 9/02; G06F 16/248

(57) ABSTRACT

Anomalous systems are detected in a set of systems that are monitored by technical equipment to provide a dataset of variables in respect of each system, representing parameters of the system. The datasets are partitioned into at least two partitions by variable. In respect of each partition, a distance is derived in respect of each system in a dimensionally reduced ordination space. Systems are detected as being anomalous on the basis of a joint distance quantity in respect of each system derived from the distances derived in respect of each partition.

The present invention relates to the detection of anomalous systems in a set of systems that are monitored by technical equipment.

Many types of system are monitored by technical equipment, typically providing a dataset of variables in respect of each system. The variables may represent parameters of the system.

In such a case it is desirable to detect anomalous systems on the basis of the dataset. In typical examples, the number of systems may be great and the size of datasets may be large, which can make it difficult to provide reliable detection of anomalous systems.

Merely by way of example, the systems may comprise a utility supply and the technical equipment may comprise utility meters. Energy theft by physical tampering of meters is significant, for example being thought to account for up to £400M p.a. in lost revenue to the UK energy industry. The current and future deployment of up to 50M smart meters across the UK industry carries both consumer and provider benefits, but also opens the potential of new avenues for cyber fraud which is of significant concern to the industry.

Electricity smart meters typically collect standardized consumption data (KwH in 48 half-hour bins per day) used for billing. An associated stream of non-standardized “event” (or “logging”) data is typically also collected by the smart meter. This event data may for example consist of circa 250 nominal codes for a variety of events such as “User logged on to modem”, “User reset password”, “Condition latched from unlatched”, and many more of increasingly technical nature. In principle, such a dataset of consumption data and event data might be used to detect anomalous supplies, for example which indicate meter tampering for theft, fraud, or otherwise. However, there is not yet known whether such meter tampering carries with it a specific and detectable event sequence signature.

More generally, for typical datasets relating to different types of system, it can be difficult to identify a signature in the dataset that is indicative of anomalous systems in a reliable manner.

According to a first aspect of the present invention, there is provided a method of detecting anomalous systems in a set of systems that are monitored by technical equipment to provide a dataset of variables in respect of each system, which variables represent parameters of the system and/or the technical equipment, the method comprising: (a) partitioning the datasets into at least two partitions by variable; (b) in respect of each partition, deriving a distance in respect of each system in a dimensionally reduced ordination space; (c) detecting systems as being anomalous on the basis of a joint distance quantity in respect of each system derived from the distances derived in respect of each partition.

Accordingly, the method may identify joint outliers in dimension reduced ordination spaces derived from partitions in the dataset. As such, the method can detect anomalous systems from the datasets themselves using an unsupervised technique, without reference to defining sequence signatures and without the need for supervised machine learning systems that would need to be trained from credible and/or sizable training datasets of normal and anomalous systems. Specifically, the method is a generalized technique for identifying anomalous cases in a systems-by-variables dataset, because the joint distance quantities in respect of each system derived from the distances derived in respect of each partition are susceptible to statistical interpretation.

To allow better understanding, embodiments of the present invention will now be described by way of non-limitative example with reference to the accompanying drawings, in which:

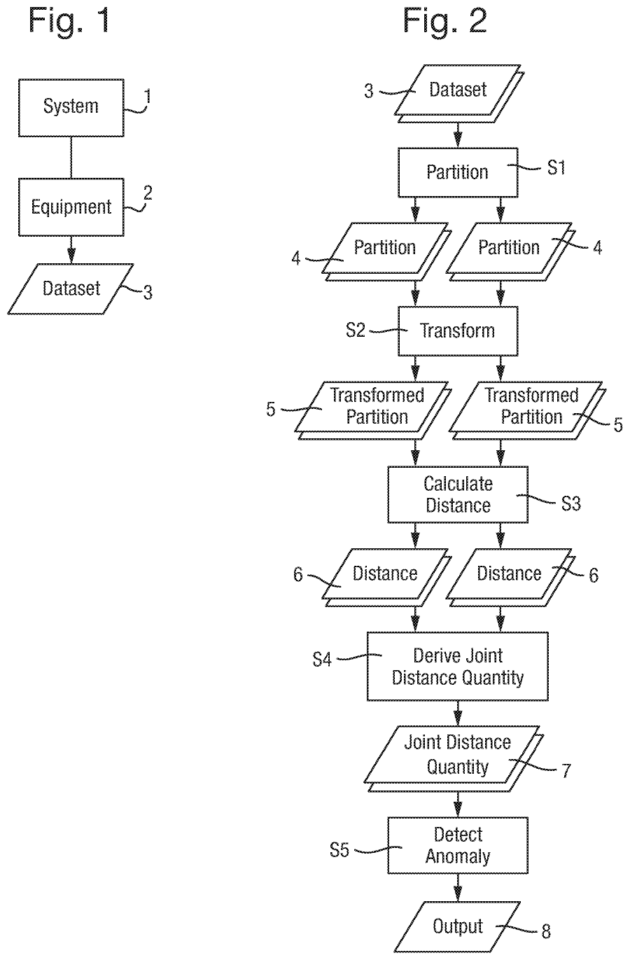

FIG. 1 is a schematic diagram of a system monitored by technical equipment;

FIG. 2 is a flowchart of a method of detecting anomalous systems;

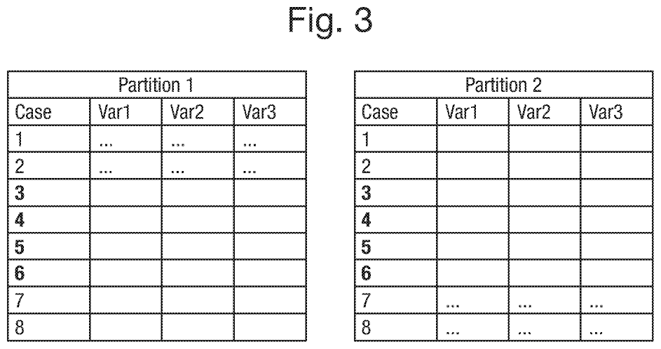

FIG. 3 is a diagram of two partitions in a simplified example;

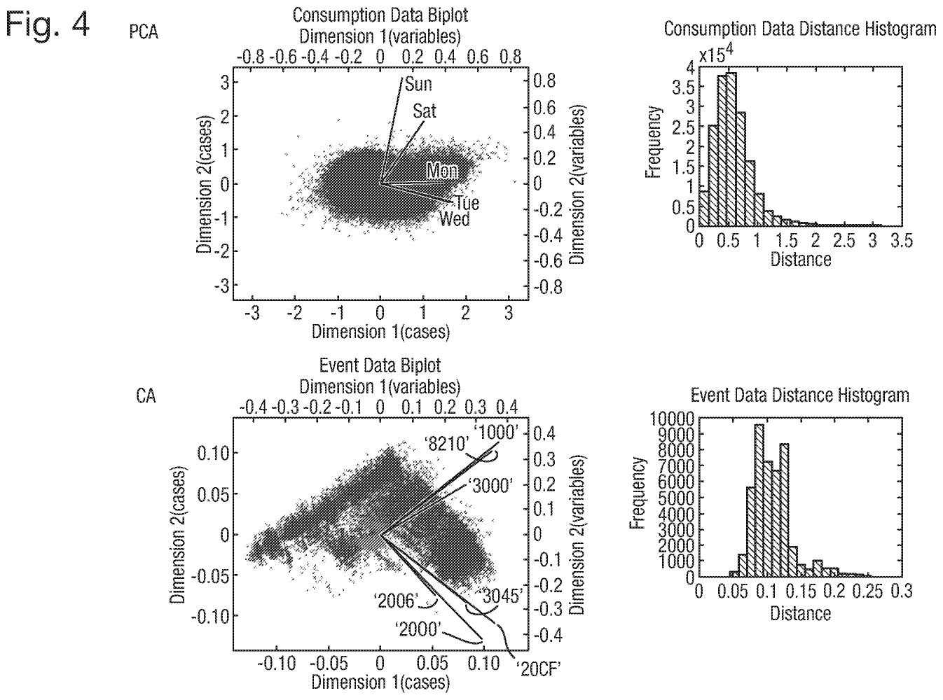

FIG. 4 is a diagram of biplots of dimensionally reduced ordination space in a specific example, together with histograms showing the distribution of distances in the dimensionally reduced ordination space;

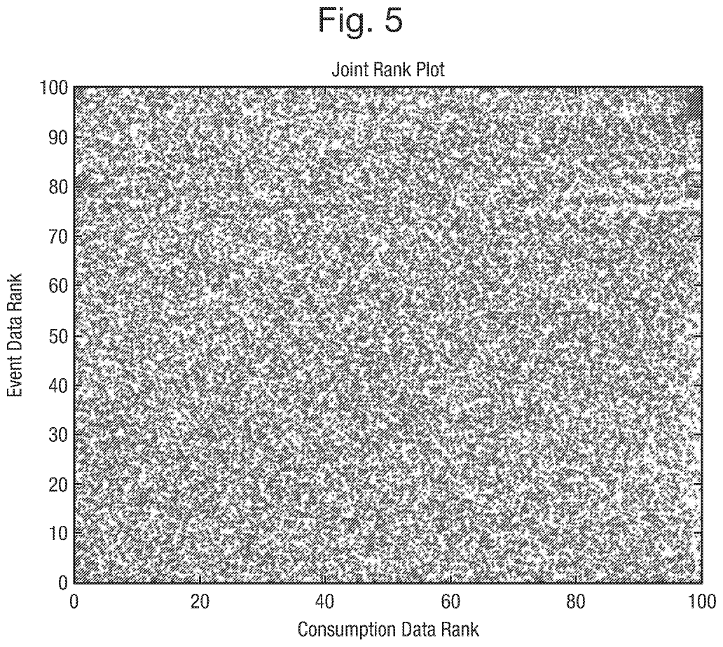

FIG. 5 is a joint rank plot of the distances in the example of FIG. 4;

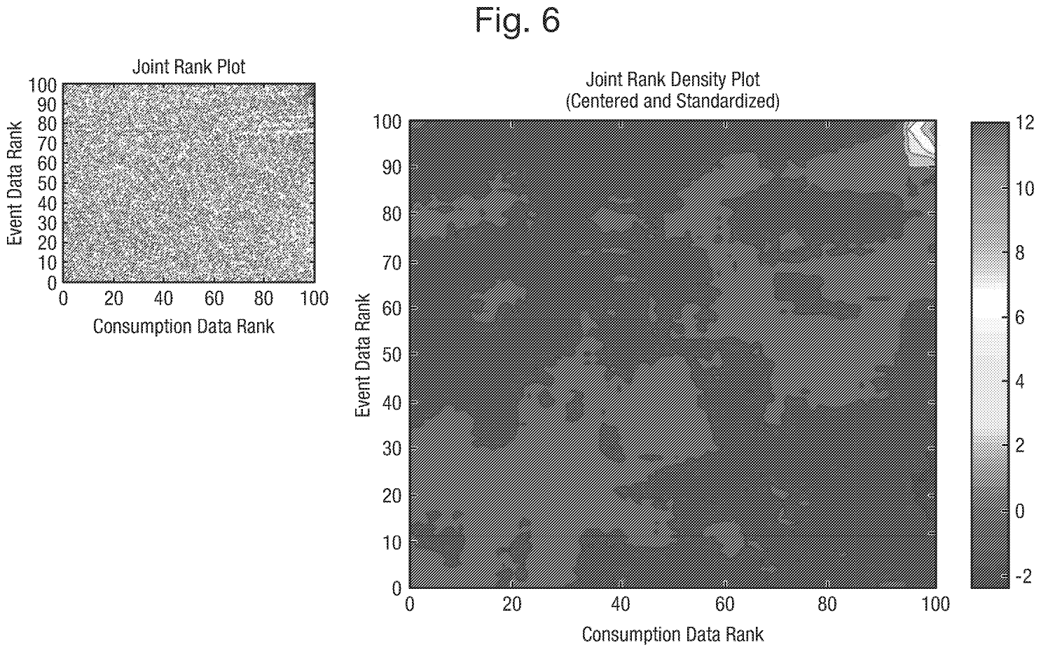

FIG. 6 is a contour plot of the density of the joint rank plot of FIG. 5;

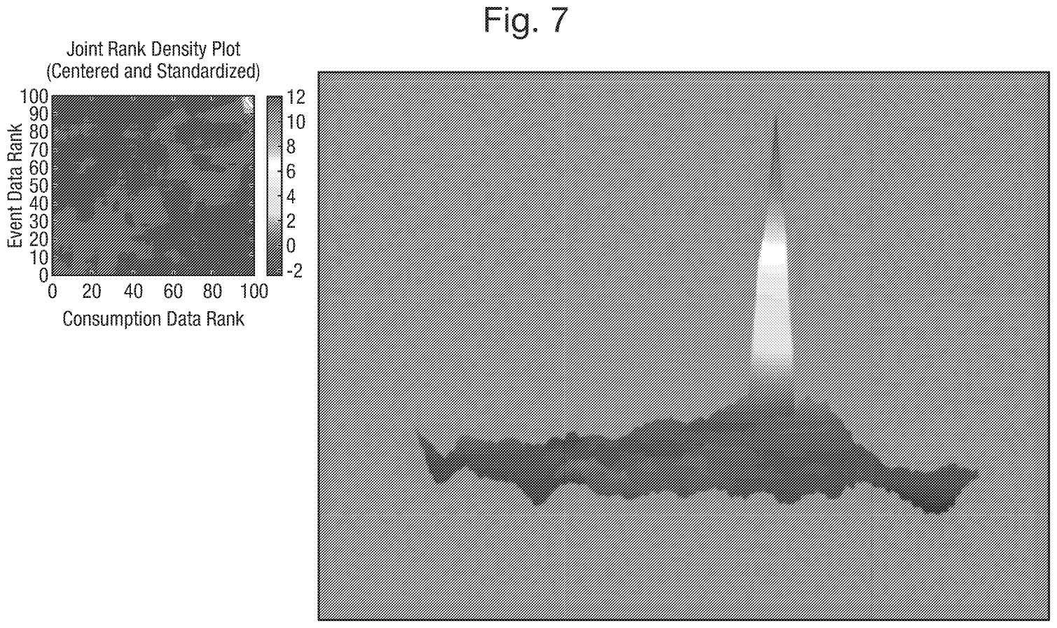

FIG. 7 is a surface plot of the density of the joint rank plot of FIG. 5; and

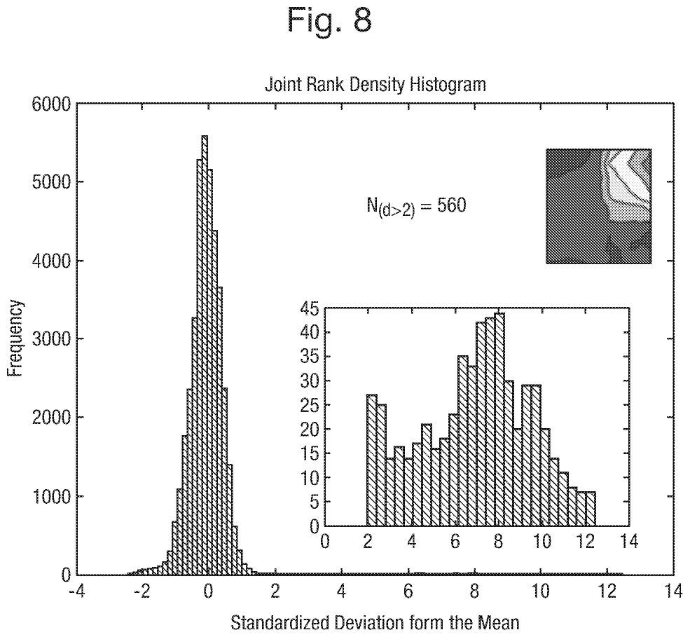

FIG. 8 is a histogram of the density of the joint rank plot of FIG. 5.

A system 1 monitored by technical equipment 2 is illustrated schematically in FIG. 1. The technical equipment 2 provides a dataset 3 of variables in respect of the system 1. Such variables represent parameters of the system 1 and/or the technical equipment 2. For example, the technical equipment 2 may comprise an array of sensors which sense parameters of the system 1, or may comprise an experimental apparatus that takes measurements of parameters of the system 1. Typically, there are relatively large numbers of variables in a dataset 3, for example tens or hundreds of variables, or more.

Typically, a set of systems 1 as shown in FIG. 1 may be provided, each monitored by technical equipment 2 to provide respective datasets 3. Typically, there are relatively large numbers of systems 1 in the set, for example more than a thousand, or up to many orders of magnitude more.

In general, the system 1 and the technical equipment 2 may be any of a wide range of types. Some non-limitative examples provided merely for the sake of illustration are as follows.

In a first example, the systems 1 may be utility supplies, for example a gas, electricity or water supply. In that case, technical equipment 2 may comprises utility meters. Utility meters typically provide datasets representing various information, such as consumption data and event data. In this example, anomalous systems 1 that are desirable to detect may be utility supplies that have been tampered with, e.g. due to energy theft or fraud.

In a second example, the systems 1 may be pieces of machinery, for example an engine such as a jet engine or an internal combustion engine. In that case, the technical equipment 2 may comprise an array of sensors. Engines and pieces of machinery in general are monitored by large numbers of sensors to monitor parameters of the pieces of machinery representing its operation and performance. In this example, anomalous systems 1 that are desirable to detect may be pieces of machinery whose operation is faulty or unsafe.

In a third example, the systems 1 may be biochemical samples, for example samples from patients or other sources. In that case, the technical equipment 2 may be equipment for performing a biochemical study of the samples. In general, such a biochemical study may be of any of a wide range of types, but one example is a study of protein production rates which may be indicative of gene expression rates, and/or a study of amino acids, bases or genes. In this example, anomalous systems 1 that are desirable to detect may be biochemical samples where the biochemistry that is studied is an abnormal case.

In a fourth example, the systems 1 may be data networks or parts of a data network. In that case, the technical equipment 2 may comprise various network components that provide information on the operation of data network, for example network traffic and/or parameters of the hardware over which data is transferred. In this example, anomalous systems 1 that are desirable to detect may be data networks or parts of a data network whose operation is abnormal.

In a fifth example, the system 1 may be data files, for example data files in a computer apparatus or network. In that case, the technical equipment 2 may comprise components of a computer apparatus or network that indicate parameters of the data files. In this example, anomalous systems 1 that are desirable to detect may be data files that are abnormal.

The variables in the dataset 3 may be of various types, depending on the nature of the system 1 and the technical equipment 2 that monitors the system 1.

Some or all of the variables in the dataset 3 may be nominal-scale variables. For example, such nominal-scale variables may represent the occurrence of events in the system 1. Such variables may for example be codes representing particular events. The variables may have an associated time, for example being time-stamped.

Variables that are nominal scale variables may be pre-processed by transforming them into a numeric representation, for example by numeric recoding, frequency count, or other means. Frequency counting is advantageous, but numeric recoding is an alternative. For example, if the partitions are made at random in step S1 described below and repeated sampling is performed, and if randomized numeric coding is applied with each repetition, then the association between codes remains unbiased.

By way of illustration, in the first example above where the system 1 is a utility supply and the technical equipment 2 is a utility meter, then the dataset 3 may include nominal-scale variables that represent the occurrence of events, typically referred to as “event data”.

Some or all of the variables in the dataset 3 may be ratio-scale variables. For example, such ratio-scale variables may represent parameters of the system 1, for example related to operation of the system 1. Such ratio-scale variables may represent parameters of the system 1 at successive times within a time frame under consideration. Such variables may represent parameters in successive time slots within the time frame under consideration, e.g. time-binned data. In this case, it may be desirable to select time slots that allow capture of a cyclical frequency that is relevant to the set of systems 1.

By way of illustration, in the first example above where the system 1 is a utility supply and the technical equipment 2 is a utility meter, then the dataset 3 may include ratio-scale variables that represent consumption values over time, i.e. relating to consumption of the utility, typically referred to as “consumption data”. In this case, the time slots may be selected to capture of cyclical frequency relevant to observed consumption. There are clear daily, weekly, and seasonal energy consumption patterns, and although these cycles differ between domestic and commercial properties, they remain the dominant patterns for both types of property. For example, the time slots may be a day. This may be achieved by recoding the consumption data collected by typical smart meters in standard half-hourly bins into time slots of a day, averaged by day of the week. However, this is not limitative and there are many other coding possibilities.

A method of detecting anomalous systems 1 in a set of systems, using the datasets 3 provided in respect of each systems, is shown in FIG. 2.

The method may be implemented in a computer apparatus. To achieve this, a computer program capable of execution by the computer apparatus may be provided. The computer program is configured so that, on execution, it causes the computer apparatus to perform the method.

The computer apparatus, where used, may be any type of computer system but is typically of conventional construction. The computer program may be written in any suitable programming language. The computer program may be stored on a computer-readable storage medium, which may be of any type, for example: a recording medium which is insertable into a drive of the computing system and which may store information magnetically, optically or opto-magnetically; a fixed recording medium of the computer system such as a hard drive; or a computer memory.

The method is performed on a dataset 3 derived in respect of a time frame. The time frame may be chosen to have a sufficient period to provide a sufficient amount of data for effective detection of anomlies. Thus, the time frame depends on the nature of the set of systems 1 and the technical equipment 2, and may in general be selected by considering the datasets 3 and different possible time frames. For example, in the case of variables that represent the occurrence of events, this may depend on the number of possible events and their frequency of occurrence.

In the case of datasets 3 in respect of a set of systems 1 that are gas supplies provided by gas meters, then an effective period may be of the order of months, for example three months. This is long enough to reduce the number of events having a zero count which could effectively cause potentially relevant data to be ignored, while being short enough to prevent anomalous data produced by the event of a meter tamper to be so diluted by the background of normal operation as to go undetected.

The method of FIG. 2 is performed as follows.

In step S1, each datasets 3 is portioned into at least two partitions 4 by variable. FIG. 2 illustrates an example of two partitions 4, but in general a large number of partitions 4 may be used. In general terms, cases (systems 1) need not be present in all partitions 4 (or a case may have null values across the variables in a partition 4) but anomalous systems 1 can be detected only from the set of systems 1 in common across all partitions 4.

By way of illustration, FIG. 3 shows partitions for a simplified example of partitioning a data set for eight cases (systems 1) into two partitions 4 of three variables. In a real example, there may be any plural number of partitions 4, the total number of cases (systems 1) will typically be much greater, and the total number of variables in the datasets 3 and in each partition will typically be much greater.

The partitioning in step S1 may be performed in various manners, some examples of which are as follows.

A first partitioning example may be applied to datasets 3 where the variables include nominal-scale variables and ratio-scale variables. In this partitioning example, the datasets 3 may be partitioned into at least one partition 4 comprising the nominal-scale variables and at least one partition 4 comprising the ratio-scale variables. This allows the nominal-scale variables and the ratio-scale variables to be processed in different manners in the steps described below.

In a second partitioning example, the datasets 3 may be partitioned into at least two partitions 4 randomly by variable. This is particularly suitable for variables of the same type. In this second partitioning example, the method may be repeated a plurality of times, but with the datasets 3 being partitioned into different partitions 4 by variable in step S1 each repetition, as described below.

The first and second partitioning examples may be combined. In this case, the datasets 3 may be partitioned into plural partitions 4 comprising the nominal-scale variables randomly by nominal-scale variable and/or into plural partitions 4 comprising the nominal-scale variables randomly by nominal-scale variable.

Step S2 is performed in respect of each partition. In step S2, the partitions 4 are transformed into transformed partitions 5 by transforming the variables of each partition 4 into a dimensionally reduced ordination space.

In general, step S2 may employ any dimension reduction technique. Many such dimension reduction techniques are known in themselves. Without limitation, the dimension reduction technique may be Bayesian or non-Bayesian and/or may be may be a linear or non-linear technique.

Step S2 may also be performed using a machine learning technique.

Advantageously, step S2 may use a singular value decomposition (SVD) technique, for example using correspondence analysis (CA), principal component analysis (PCA), log-ratio analysis (LRA), and/or various derived methods of discriminant analysis. Different types of analysis may be applied to different partitions 4. Correspondence analysis (CA) may be applied, for example, to a partition 4 that comprises nominal-scale variables. Principal component analysis (PCA) may be applied, for example, to a partition 4 that comprises ratio-scale variables.

A biplot of the type disclosed for example in Reference 1 provides a convenient visualization of step S2, but is not itself integral to the technique. The method is illustrated herein various kinds of plots, including biplots.

A biplot as disclosed in Reference 1 is a graphical device that shows simultaneously the rows and columns of a data matrix as points and/or vectors in a low-dimensional Euclidean space, usually just two or three dimensions. Reference 5 introduces the contribution biplot in which the right singular vectors (column contribution coordinates) of a dimension reduction analysis show, by their length, the relative contribution to the low-dimension solution. Contribution biplots can be used with any of the methods that perform dimension reduction using a SVD technique.

SVD may be considered as a factorization of a target matrix T such that

T=UΓV^{T} (Equation 1)

What distinguishes the various methods is the form of the normalization applied to T before performing the SVD. In CA, this normalization is the matrix of standardized residuals

T=Dᵣ^{-1/2}(P−rc^{T})D_{c}^{-1/2} (Equation 2)

where P is the co-called correspondence matrix P=N/n with N being the original data matrix and n its grand total, row and column marginal totals of P are r and c respectively, and Dr and Dc are the diagonal matrices of these.

In the analysis of a cases-by-variables data matrix, the right singular vectors of the SVD, V, are the contribution coordinates of the columns (variables). A further transformation involving a scaling factor D_{q}, such that

F=D_{q}^{-1/2}UΓ (Equation 3)

defines the principal coordinates of the rows (cases). The joint display of the two sets of points in F and V can often be achieved on a common scale, thereby avoiding the need for arbitrary independent scaling to make the biplot legible. The appropriate normalizations and the derivation of scaling factors for the alternative methods are detailed in various equations given in Reference 5.

For partitions 4 comprising variables that are nominal scale variables, CA may be used, following a triple log transform of the frequency data N₀ such that

N=ln(ln(ln(N₀)+1)+1)+1 (Equation 4)

This is a convenience, introducing an appropriate scaling so as to make the biplot legible.

For partitions 4 comprising variables that are ratio-scale variables, the formulation of PCA given in Reference 5 may be used, after centering and standardizing the input data by variable.

Any such ordination techniques, for example CA or PCA, result in a matrix F of principal coordinates of the rows (cases) as in Equation (3). This matrix has the same number of dimensions (columns) as variables in the raw input data, however the information content of the data is now concentrated towards the higher order components (i.e. towards the left-most columns of F). This is the central purpose of the dimension reduction performed by SVD, and typically, a scree plot is used to inspect the degree of dimension reduction, essentially a plot of the eigenvalues set out in Γ in Equation 1.

A decision needs to be made as to how many components to retain, referred to as a stopping rule in References 6 and 7. A conventional stopping rule that may be applied is to retain only those components with corresponding eigenvalues>1 (known as the Kaiser-Guttman criterion), though this is a tunable parameter of the method and a range of values can be explored.

Step S3 is performed in respect of each transformed partition 5. In step S3, a distance 6 in respect of each system 1 in the dimensionally reduced ordination space of the respective transformed partition 5. This distance 6 may be for example the distance in the respective space between the transformed variables and the origin. The distance may be a Euclidean distance, which may derived, for example using the following Matlab Code:

d=sum(F(:, 1:k).\hat{ }2,2).\hat{ }(1/2)

By way of illustration, FIG. 4 shows an example for datasets 3 in respect of a set of systems 1 that are gas supplies provided by gas meters, where the datasets 3 comprise event data and consumption data. Specifically, FIG. 4 shows biplots of the dimensionally reduced ordination spaces comprising the first two dimensions of the multi-dimensional result of the PCA and CA analyses of the consumption data and the event data, wherein each system 1 is plotted. The distances 6 derived in step S3 are the distances from the origin of each system in the dimensionally reduced ordination spaces. FIG. 4 also shows histograms showing the distribution of these distances 6.

Although FIG. 4 illustrates a dimensionally reduced space of two dimensions for ease of visualisation, the dimensionally reduced space may comprise any plural number of dimensions.

Considering the consumption data biplot in FIG. 4, interpreting the vectors of the variables (days of the week), we see the weekend being orthogonal to weekdays as we might expect for small business properties. The cloud of cases is roughly elliptical in the first two dimensions with clearly identifiable outliers but none that would necessarily arouse suspicion. This step provides significant dimension reduction. The Kaiser-Guttman rule selects only the first two components with eigenvalues>1, however these two components account for only 45.36% of the variance of the original data.

Considering the event data biplot in FIG. 4 in the first two dimensions a hand-full of variables dominate the solution in two orthogonal sets. The rest of the variables contribute only a minor influence on the solution. The Kaiser-Guttman rule selects about 20 out of circa 150 variables with eigenvalues>1, and these account for 88.61% of the variance of the original data.

In step S4, a joint distance quantity 7 is derived in respect of each system from the distances derived in respect of each partition 4 in step S3. The joint distance quantity 7 may be of various different types, for example as follows.

A first option is that the joint distance quantity 7 is a vector quantity comprising the distances 6 derived in respect of each partition 4. In this case, the joint distance quantity 7 is derived simply by relating together the distances 6 derived in respect of each partition 4.

A second option is that the joint distance quantity 7 is a vector quantity comprising the rank orders of the distances 6 derived in respect of each partition 4. In this case, the distances 6 derived in step S3 in respect of each partition 4 are first rank ordered, and then the rank orders in respect of each partition 4 are related together.

A third option is that the joint distance quantity 7 is a scalar quantity representing a distance measure in a space whose dimensions are the distances 6 derived in respect of each partition 4. In this case, the distance measure is derived from the distances 6 derived in respect of each partition 4. Any suitable distance measure may be used, for example a product, a Euclidean distance or any other distance measure.

A fourth option is that the joint distance quantity 7 is a scalar quantity representing a distance measure in a space whose dimensions are the rank orders of the distances 6 derived in respect of each partition 4. In this case, the distances 6 derived in step S3 in respect of each partition 4 are first rank ordered, and then the distance measure is derived from rank orders in respect of each partition 4. Any suitable distance measure may be used, for example a product, a Euclidean distance or any other distance measure.

Joint distances that involve rank ordering, for example the second and fourth options, are particularly suitable where the partitions represent variables having different types and/or scales.

In step S5, systems 1 are detected as being anomalous on the basis of a joint distance quantities 7 derived in respect of each system. Step S5 produces an output 8 identifying the systems 1 that are detected as being anomalous. Step S5 is performed on the following basis. If all the data across all the variables were generated by independent random processes, then there would be no relationship between the distances 6 derived in respect of each partition 4, but if the variables are at least partially correlated (as is typically the case for real-word data) then we would expect a correlation between the distances 6 derived in respect of each partition 4, but we would still expect an even spread of associations. Thus, systems 1 may be detected as anomalous where the joint distance quantities 7 in respect of the systems 1 are anomalous compared to the distribution joint distances in respect of all the systems 1.

Similarly, systems 1 may be detected as anomalous on the basis of the density of the joint distance quantities. For example the density of the points may be derived the departure from the mean density may be inspected. The density may be rescaled by its standard deviation to allow this inspection to be performed in units of standard deviation. Cases at the far extremes of departure from the mean be interpreted as being so divorced from the background process generating the bulk of the data as to be anomalies produced by a different mechanism from the other data. Thus, step S5 may finds those systems 1 at the far extremes of departure from the mean density, and to report them as likely anomalies that require an alternative explanation.

This is related to outlier detection in the data science and machine learning literature. An outlier, in a well-known definition by Hawkins in Reference 2 is “an observation which deviates so much from other observations as to arouse suspicion that it was generated by a different mechanism”, or according to Barnett and Lewis in Reference 3, “an observation [ . . . ] which appears to be inconsistent with the remainder of that set of data”. We refer to this concept of outlier as an anomaly, to emphasize their origin in a different underlying mechanism, and to distinguish them from outliers in the long tail of a statistical distribution produced by a unified mechanism. As such, the method may be described as detecting outlier intersections based on the transformations in step S2.

To illustrate the detection, FIGS. 5 to 8 illustrate an instance of the method applied to the same dataset as FIG. 4. In this example, the joint distance quantity 7 is a vector quantity comprising the rank orders of the distances 6 derived in respect of each partition 4. Thus, FIG. 5 shows a rank plot of the joint distance quantity 7 in the two dimensions defined by the rank orders of the distances 6 derived in respect of each partition 4, that is each point represents the joint distance quantity 7 in respect of a system 1.

FIG. 5 shows for this example that for the most part the data in the two partitions 4 is produced by two random and independent processes, as the cloud of data points across the entire space is relatively even. If the variables in the two partitions 4 were partially correlated, an increased density of points towards the diagonal would be expected (and this can also be demonstrated by simulation). But in the case of a unified underlying process significant variation in density of points along the diagonal would not be expected. However, for this example, there is a distinct cluster of high density at high ranks in the upper right corner, which is representative of those systems 1 being anomalous.

FIG. 6 shows the density of the joint ranks as a contour plot, where density has been scaled to units of standard deviation. The high density cluster in the upper right corner is from two to 12 standard deviations away from the mean of the background process. A slight concentration towards the diagonal is also evident for the background process.

FIG. 7 shows the same scaling as a surface plot. The spike in density may be interpreted as indicating a set of anomalous systems that are derived from a different underlying mechanism to the rest of the datasets 3. Similarly, FIG. 8 illustrates the long tail of the distribution and shows just 560 cases with a standard deviation greater than two, out of a datasets 3 of some 40 k systems.

Optionally, the method may be performed repeatedly in either or both of the following ways.

Firstly, where the second partitioning example described above is employed, steps S1 to S5 may be repeated a plurality of times, but with the datasets 3 being partitioned into different partitions 4 by variable in step S1 of each repetition. In this case, the results from each repetition may be combined to provide a confidence interval (a kind of statistical jack knifing).

Secondly, where the datasets 3 comprise variables in successive time frames, then steps S1 to S5 may be repeated in respect of each time frame. Deploying the method in this manner with a sliding time-window across a set of systems 1 shows the evolution of anomalous behaviour (i.e. when systems 1 start and cease to be anomalous) which may provide significant insights.

The method described here has been implemented in software and applied to the large number (greater than 1000) of benchmark datasets published by Campos et. al. in Reference 4. These datasets include a ground-truthed classification of outliers that can be used to evaluate the relative performance of different outlier detection methods. Reference 4 also provides results of applying many of the most widely used existing standard techniques. By evaluating the commonly accepted measure of performance (ROC, receiver operator characteristic) it has been shown that the present method performs better than most of the standard methods across all the datasets presented in Reference 4, at least as well as the best of the standard methods for many of the datasets presented in Reference 4, and most significantly, more consistently better than any of the standard methods presented in Reference 4.

### REFERENCES

Reference 1: M. Greenacre. “Contribution biplots.” Journal of Computational and Graphical Statistics, 22, pp. 107-122, (2013)
Reference 2: D. Hawkins. Identification of Outliers. Chapman and Hall, London (1980)
Reference 3: V. Barnett, T. Lewis. Outliers in Statistical Data. 3rd edn. Wiley, New York (1994)
Reference 4: G. O. Campos, A. Zimek, J. Sander, R. J. G. B. Campello, B. Micenkov'a, E. Schubert, I. Assent, M. E. Houle. “On the evaluation of unsupervised outlier detection: measures, datasets, and an empirical study.” Data Mining and Knowledge Discovery, 30, pp. 891-927, (2016)
Reference 5: L. Akoglu, H. Tong, D. Koutra. “Graph-based anomaly detection and description: a survey.” Data Mining and Knowledge Discovery, 29, pp. 626-688, (2015)
Reference 6: D. A. Jackson. “Stopping rules in principal components analysis: A comparison of heuristical and statistical approaches.” Ecology, 74, pp. 2204-2214, (1993)
Reference 7: P. R. Peres-Neto, D. K. Jackson, K. M. Somers. “How many principal components? Stopping rules for determining the number of non-trivial axes revisited.” Computational Statistics and Data Analysis, 49, pp. 974-997, (2005)

1. A method of detecting anomalous systems in a set of systems that are monitored by technical equipment to provide a dataset of variables in respect of each system, which variables represent parameters of the system and/or the technical equipment, the method comprising:
(a) partitioning the datasets into at least two partitions by variable;
(b) in respect of each partition, deriving a distance in respect of each system in a dimensionally reduced ordination space;
(c) detecting systems as being anomalous on the basis of a joint distance quantity in respect of each system derived from the distances derived in respect of each partition.

2. A method according to claim 1, wherein at least one of the partitions comprise nominal-scale variables.

3. A method according to claim 2, further comprising transforming the nominal-scale variables into a numeric representation.

4. A method according to claim 2, wherein the nominal-scale variables are represent the occurrence of events.

5. A method according to claim 1, wherein the at least one of the partitions comprise ratio-scale variables.

6. A method according to claim 5, wherein the technical equipment comprises utility meters and the ratio-scale variables represent consumption values over time.

7. A method according to claim 1, wherein the variables include nominal-scale variables and ratio-scale variables, and said step of partitioning the datasets into at least two partitions comprises partitioning the datasets into at least one partition comprising the nominal-scale variables and at least one other partition comprising the ratio-scale variables.

8. A method according to claim 1, wherein said step of partitioning the datasets into at least two partitions is performed randomly by variable.

9. A method according to claim 1, wherein said step of deriving a distance uses a singular value decomposition technique.

10. A method according to claim 1, wherein said step of deriving a distance in respect of each system uses principal component analysis in respect of at least one partition of the at least two partitions.

11. A method according to claim 1, wherein said step of deriving a distance in respect of each system uses correspondence analysis in respect of at least one partition of the at least two partitions.

12. A method according to claim 1, wherein the joint distance quantity is a vector quantity comprising the distances derived in respect of each partition.

13. A method according to claim 1, wherein the joint distance quantity is a vector quantity comprising the rank orders of the distances derived in respect of each partition.

14. A method according to claim 1, wherein the joint distance quantity is a scalar quantity representing a distance measure in a space whose dimensions are the distances derived in respect of each partition of the at least two partitions, or a distance measure in a space whose dimensions are the rank orders of the distances derived in respect of each partition of the at least two partitions.

15. A method according to claim 1, wherein step (c) comprises detecting systems as anomalous where the joint distance quantities in respect of the systems are anomalous compared to the distribution joint distances in respect of all the systems.

16. A method according to claim 1, wherein step (c) comprises detecting systems as anomalous on the basis of the density of the joint distance quantities.

17. A method according to claim 1, wherein the dataset comprises variables in successive time frames, and steps (a) to (c) are repeated in respect of each time frame of the successive time frames.

18. A method according to claim 1, wherein steps (a) to (c) are repeated a plurality of times with step (a) comprising partitioning the datasets into different partitions by variable for each time of the plurality of times.

19. A method according to claim 1, wherein the system comprises a utility supply and the technical equipment comprises utility meters.

20. A method according to claim 1, wherein the systems comprise pieces of machinery.

21. A method according to claim 20, wherein the pieces of machinery are engines.

22. A method according to claim 1, wherein the systems comprise data networks or parts of a data network.

23. A method according to claim 1, wherein the systems comprise biochemical samples and the technical equipment comprises equipment for performing a biochemical study.

24. A method according to claim 1, wherein the systems comprise data files.

25. A computer program capable of execution by a computer apparatus and configured, on execution, to cause the computer apparatus to:
(a) partition the datasets into at least two partitions by variable;
(b) in respect of each partition, derive a distance in respect of each system in a dimensionally reduced ordination space; and
(c) detect systems as being anomalous on the basis of a joint distance quantity in respect of each system derived from the distances derived in respect of each partition.

26. A computer-readable storage medium storing a computer program executable in at least one computer apparatus according to claim 25.

27. A computer apparatus, having at least one application executable in the computer apparatus, that when executed by the computer apparatus causes the computer apparatus to:
(a) partition the datasets into at least two partitions by variable;
(b) in respect of each partition, derive a distance in respect of each system in a dimensionally reduced ordination space; and
(c) detect systems as being anomalous on the basis of a joint distance quantity in respect of each system derived from the distances derived in respect of each partition.
